(19) United States
(12) Patent Application Publication
(10) Pub. No.: US 2009/0192863 A1
(43) Pub. Date: Jul. 30, 2009

(54) Incentive card program for attracting persons to product or service displays

(76) Inventors: Joseph J. Macaluso, Andover, NJ (US); Kris Lakshmanan, Piscataway, NJ (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/228,149

(22) Filed: Aug. 8, 2008

Related U.S. Application Data
(60) Provisional application No. 60/954,792, filed on Aug. 8, 2007.

(51) Int. Cl. G06Q 30/00; G06Q 20/00; G06Q 10/00; G06Q 50/00; G06Q 40/00

(52) U.S. Cl. 705/9; 705/39; 705/14; 705/41

(57) ABSTRACT

Methods, systems, and techniques for marketing products are provided. Example embodiments provide an Incentive Card Program System (“ICPS”), which enables vendors to attract potential customers to product displays. In one embodiment, the ICPS comprises an incentive card program along with services in the form of hardware, software, or firmware to implement the functions of the program running for example on a computing system associated with product displays, such as a kiosk. In some embodiments, the ICPS optionally includes a portal, accessible over a network such as the Internet, for incentive card holders to obtain information related to their incentive cards. These components cooperate to provide services relating to incentive card programs. This abstract is provided to comply with rules requiring an abstract, and it is submitted with the intention that it will not be used to interpret or limit the scope or meaning of the claims.

### TECHNICAL FIELD

The present disclosure relates to methods, systems, and techniques for facilitating the marketing of products and, in particular, to methods, systems, and techniques for providing an incentive program for attracting persons to product and/or service displays.

### BACKGROUND

At marketing events such as trade shows and meetings, vendors often provide promotional items to attract potential customers to their product displays. Promotional items may include such things as pens, laser pointers, utility tools, calculators, mouse pads, mugs and T-shirts. While providing promotional items may attract potential visitors, too often the potential visitors who receive the promotional items either never end up using the items or use them only for a short time. Additionally, if other vendors are also giving away similar promotional items, it is harder for a vendor to attract potential customers to the booth by giving away promotional items as there are only so many pens or T-shirts a potential customer can use.

Furthermore, when promotional materials are given away, the information about potential customers getting the promotional items is either not captured or the procedure for capturing that information is very cumbersome and inefficient. For example, potential customers may be asked to complete a paper form. Subsequently, the collected information is typically manually processed at a large expense to the company. In recent years, badges of attendees to an event have been swiped or otherwise read by a machine in order to capture information about the attendees. At the end of the event, information about those attendees may be obtained, usually for a fee. However, since many of the promotional items are just left out, for example on tables, event attendees may be able to acquire promotional items without having their badges scanned and their information captured. In addition, often only limited information is obtained about the attendee and custom information useful to the vendor for marketing purposes cannot easily be acquired by using an event attendance badge swipe methodology.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a photograph of an example product display kiosk inside a booth at a trade show.

FIG. 2 is a photograph of an example product display kiosk/computing system implementing an ICPS according to one embodiment.

FIG. 3 is an example incentive card in the form of a debit card.

FIG. 4 is an example of instructions that may be distributed with the incentive card to an event attendee or visitor.

FIG. 5 is an example block diagram of a general purpose computing system for practicing embodiments of an Incentive Card Program System.

FIG. 6 is an example screen display of an Initial User Interface of an ICPS according to one embodiment.

FIG. 7 is an example screen display of an Enrollment Screen of an ICPS according to one embodiment.

FIG. 8 is an example screen display of an Activate the Card Screen of an ICPS according to one embodiment.

FIG. 9 is an example screen display of an Activities Menu Screen of an ICPS according to one embodiment.

FIG. 10 is an example screen display of an Update Screen of an ICPS according to one embodiment.

FIG. 11 is an example screen display of a Card Use Screen of an ICPS according to one embodiment.

FIG. 12 is an example screen display of a Request for Information Screen of an ICPS according to one embodiment.

FIG. 13 is an example screen display of a Request for Contact Screen of an ICPS according to one embodiment.

FIG. 14 is an example screen display of a Schedule Appointment Screen of an ICPS according to one embodiment.

FIG. 15 is an example screen display of a Loser screen of an ICPS according to one embodiment.

FIG. 16 is an example screen display of a Winner screen of an ICPS according to one embodiment.

FIG. 17a-17d are example screen displays of Web Portal Screenshots of an ICPS according to one embodiment.

### DETAILED DESCRIPTION

Embodiments described herein provide methods, systems, and techniques for marketing products such as by operating an incentive card program associated with one or more vendors and/or products. Example embodiments provide an Incentive Card Program System (“ICPS”), which enables vendors to attract potential customers to product displays, such as at trade show booths, meetings, or other events. ICPS comprises an incentive card program along with services in the form of hardware, software, or firmware to implement the functions of the program running for example on a computing system associated with product displays, such as a kiosk. In some embodiments, the ICPS optionally includes a portal, accessible over a network such as the Internet, for incentive card holders to obtain information related to their incentive cards.

The incentive card program of the ICPS facilitates capturing information about visitors to an event and may be associated with presenting product or service information. Each event visitor is typically viewed by a vendor as a prospective (potential) customer. The incentive card program provides potential customers with a chance to win a monetary amount in an account associated with an incentive card, thereby providing an incentive for potential customers that did not win to return to the product/service display multiple times to increase their odds of winning. The incentive card program may be customized as needed to meet a particular vendor's needs. In some embodiments, the ICPS may be used as a standalone solution although in other embodiments it may be added on as part of an existing kiosk-based solution. In addition, the ICPS may be implemented by a vendor or by a third party who provides an incentive card program service to the vendor.

In some embodiments, the incentive card program of an ICPS replaces or supplements promotional items at trade shows. Incentive cards may be distributed to potential customers such as at a booth, at event registration for a trade show, given out on the floor of the exhibit hall, and/or through a product display kiosk, or at other times associated with an event. In some instances, the cards are supplied with instructions and/or with a vendor's product/service information. After the potential customer (event attendee) receives an incentive card, the potential customer comes to the booth or other location where a related product/service display kiosk or other computing system associated with the incentive card is available. The kiosk or computing system may comprise a keyboard, a display screen, speakers, a card reader and/or other components that are used to display information and receive input from the potential customer. Various user interface screens may be displayed by software, firmware or other computing instructions provided as part of the ICPS and executed by the kiosk/computing system, for example, as a software application.

In one example embodiment, once the potential customer arrives at the kiosk/computing system, the potential customer then swipes the incentive card in a receiving device of the product display kiosk and registers the card, typically in accordance with instructions provided at the kiosk. In the process of registering, various information about the potential customer is received. In at least some embodiments, directory lookups are advantageously utilized for some of the information. The information requested from the potential customer may be customized to the vendor's needs. After registering, product or service information may be displayed to the potential customers, depending upon, for example, customizations of the ICPS for the vendor or other factors. The potential customer may request additional product information to be sent to him or her or may set up an appointment at the trade show or at another time to discuss the potential customer's needs. In some embodiments a calendaring system may be associated with the kiosk/computing system, which allows appointments to be booked without conflict with other potential customers. Also, an email may be sent to remind the potential customer of the appointment.

In addition, the potential customer can participate in a sweepstakes to win an amount of money to be deposited in an account associated with the incentive card. The ICPS may determine if the potential customer is a winner in various manners according to various embodiments. For example, in some embodiments, the vendor may set a total monetary amount to be won at the trade show and the ICPS may be configured to randomly select winners until that amount has been awarded. In other embodiments, the ICPS may be configured to randomly select one winner for a predetermined number of entries. If the potential customer is a winner, then the ICPS causes a monetary amount to be awarded by electronically depositing that amount into an account associated with the incentive card. For example, the incentive card may be associated with a banking institution that is able to provide credit and debiting functions using its standard banking network and can associate credit and debit with the incentive cards of the ICPS. In some embodiments, each winner is awarded the same amount of money, while in other embodiments multiple levels of prizes may be awarded, such as a first prize and a second prize. If the potential customer did not win, the potential customer is provided an incentive to come back multiple times to try his or her luck again.

In some embodiments, the ICPS may also integrate additional computer-implemented services to encourage a potential customer to stay at the booth longer. For example, the kiosk/computing system may allow a potential customer to make a hotel or restaurant reservation or to find a location of selected entertainment. As another example, the kiosk may offer various games relevant to the product and/or to entertain guests, e.g., children or significant others of the potential customer.

Additionally, in some embodiments, the ICPS provides information on incentive card use, such as where and when the card is used at point of sale locations. This information may be provided in near real time at the product kiosk, thereby encouraging a potential customer to return to the product kiosk. For example, the event attendee may use the incentive card to purchase a coffee at a coffee shop nearby and then return to the kiosk to see how much money is still left.

In at least some embodiments, the ICPS includes an online portal component (or other networked software), where potential customers can view various information associated with their cards through, for example, a standard web browser or other client software module. For example, a potential customer may review the balance on his or her card. Advantageously, the potential customer may see additional product and/or service information or branding information as part of the online portal. The potential customer may also review and update any information previously supplied at the kiosk/computing system or request product information be sent to the potential customer. In addition, in at least some embodiments, the potential customer may contact the vendor via the online portal, such as by clicking on a link in the online portal.

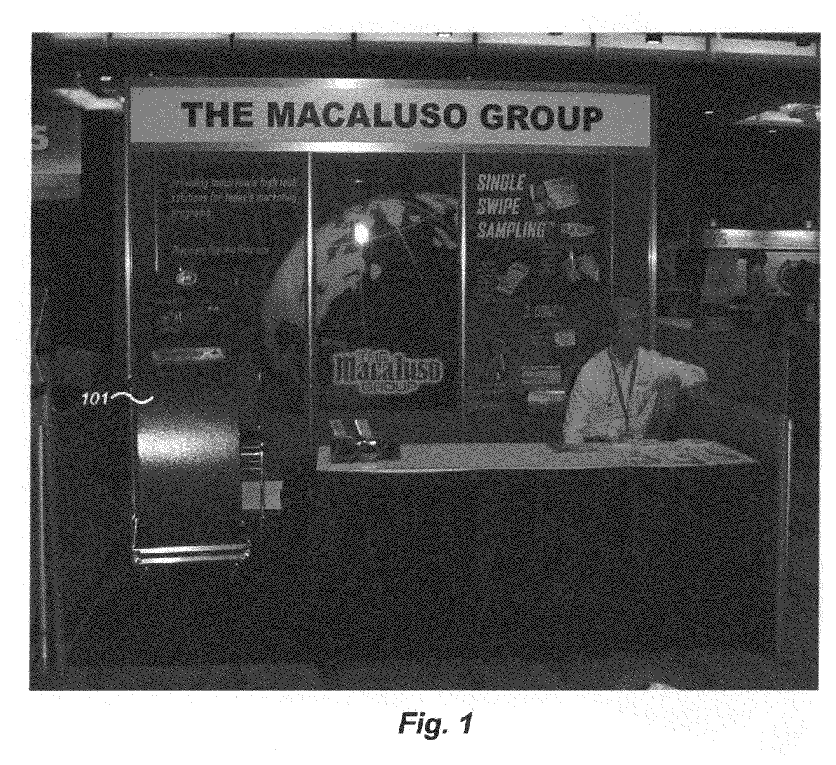

FIG. 1 is a photograph of a product display kiosk inside a booth at a trade show. Kiosk 101 hosts software of the ICPS for interacting with event attendees and visitors to receive potential customer information and display product/service information and for implementing incentives associated with an incentive card program.

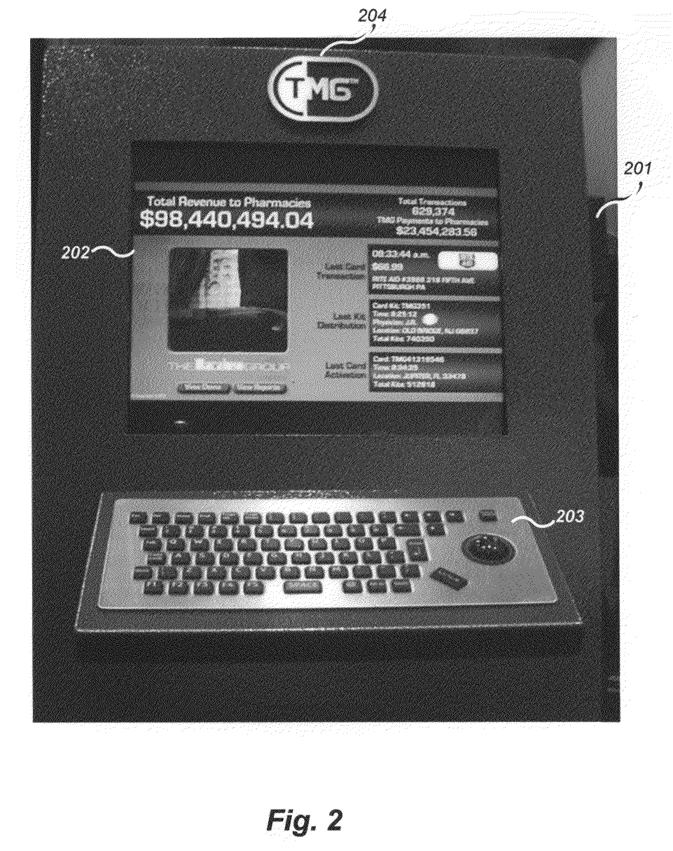

FIG. 2 is a photograph of a product display kiosk/computing system implementing an ICPS according to one embodiment. In this example, the illustrated kiosk includes a swipe device 201, a display 202, a keypad 203, and a kiosk ornament 204 for example for branding purposes. In other embodiments, the kiosk/computing system may use other input methods instead of a keypad, such as a touch screen or graphics tablet. In addition, other receiving devices may be used instead of a swipe device, such as an RFID reader. Also, other embodiments may include audio devices such as speakers and other forms for presenting information.

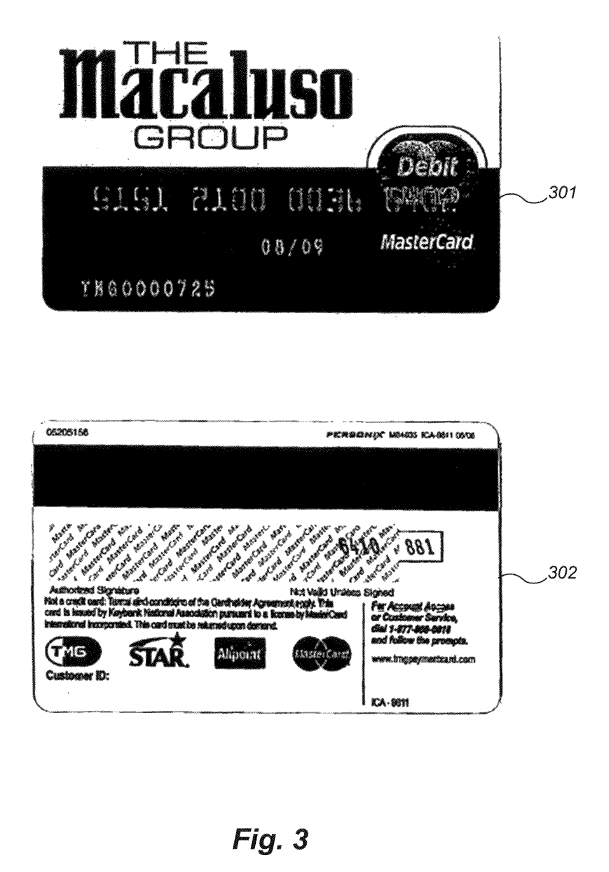

FIG. 3 is an example incentive card in the form of a debit card. Other types of cards may also be used as incentive cards. The front 301 of the card is branded according to the vendor's needs and contains a unique identifier. The back 302 of the card contains a magnetic-strip, or other appropriate information encoding medium, which allows the card to be read by the receiving device. Although the card has a MasterCard logo and thus is acceptable anywhere a MasterCard debit card would be, other types of cards may be used in other embodiments, including for example, debit and/or credit cards, or other types of cards associated with financial accounts.

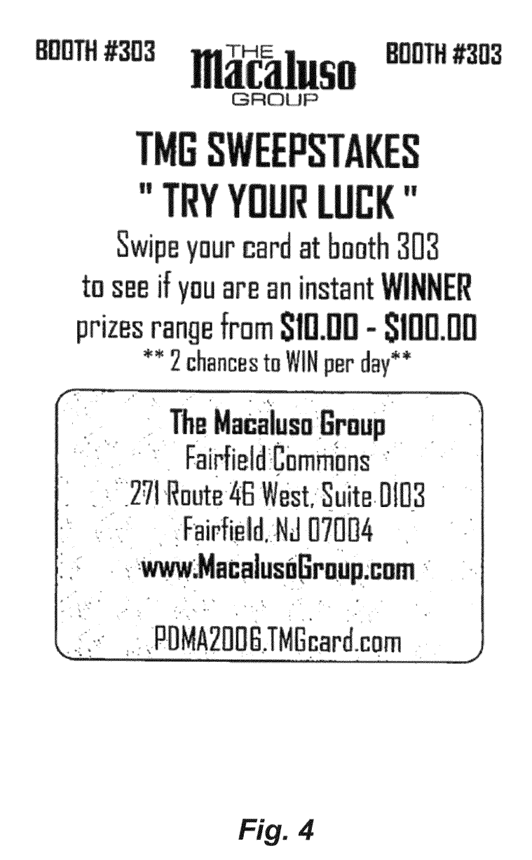

FIG. 4 is an example of instructions that may be distributed with the incentive card to an event attendee or visitor. In this example, the instructions include the booth number, the rules on how often a potential customer may win a prize, the amount of the prize that the customer may win, the name of the vendor, and a URL to the associated online portal. In other embodiments, other information may be made available and may be distributed in different forms or communicated in different ways.

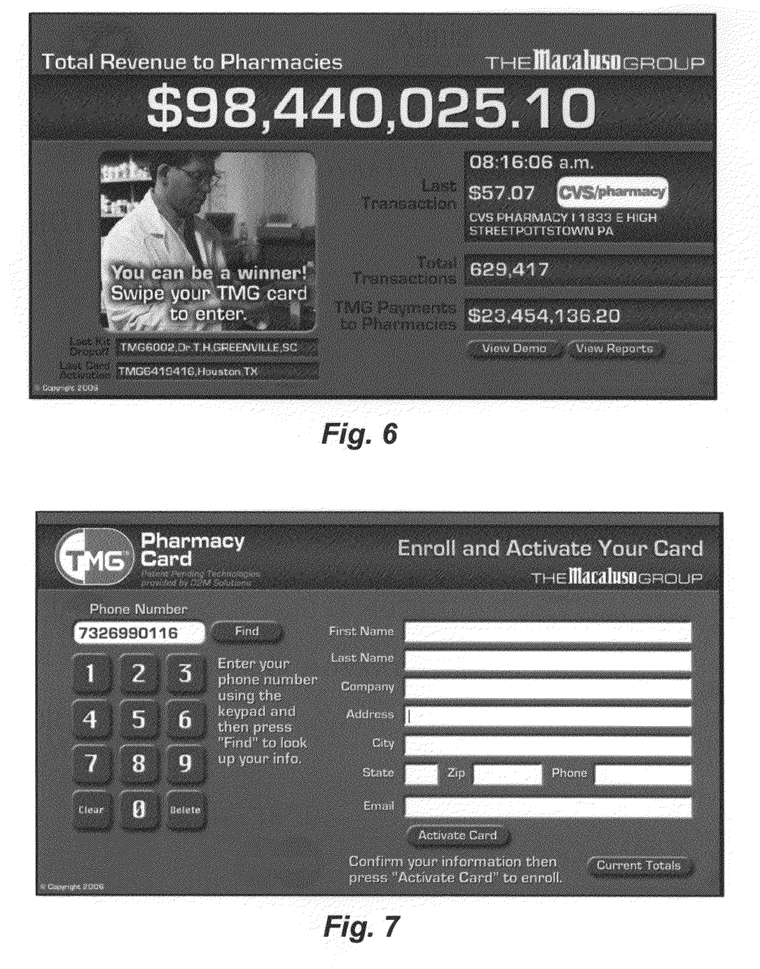

FIGS. 6-17d provide a description of various kiosk screen shots of an example kiosk based incentive card program system (“ICPS”). In addition, screen shots of an associated Web portal are also illustrated. The screen shots illustrate a kiosk/computing system branded for “The Macaluso Group” and the services it offers; however, the kiosk and the incentive card may be appropriately branded for other vendors and their products and/or services. Other customizations may be integrated in other embodiments, such as to collect more or less information from potential customers or to provide more or different incentive.

Although the term “screen” is used here extensively, the display screens presented may be display windows, dialogs, forms, templates, etc. as appropriate to the system housing the Incentive Card Program.

FIG. 6: Initial User Interface:

The initial user interface is used to attract a potential customer, for example an event attendee or visitor (“user”) to swipe the card. The user interface may have images and/or videos that change continuously to attract the attention of an audience. The image of “swipe your card” may be superimposed on the display. The rest of the presentation screen may have other product information.

When the card is swiped in an attached swipe device, an enrollment screen is shown.

FIG. 7: Enrollment Screen:

A first-time user may use the enrollment screen shown above to register and to activate his card. In the process of enrolling, the user's contact information is captured. In this example, the user may enter his contact phone number by touching the numeric keypad and entering his phone number. After entering his phone number, the user may select a “Find” button causing the kiosk to perform a lookup in an available directory service to retrieve the user's name, address and other information. The resulting information can be subsequently updated with either an attached keyboard or a virtual keyboard that is displayed on the screen.

In other embodiments, this information may also be acquired by other means, such as by reading the user's badge for the trade show.

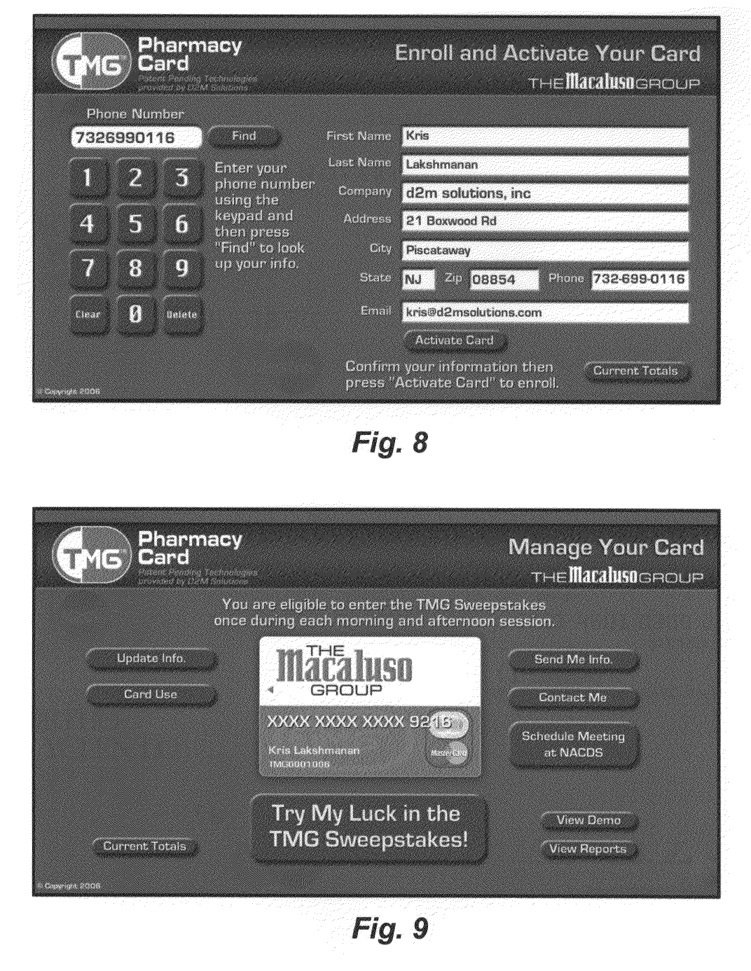

FIG. 8: Activate the Card:

After the information is correct, the user may select the “Activate Card” button to register the card to the user. Other information may be optionally obtained on one or more other screens (not shown).

FIG. 9: Activities Menu Screen:

At the completion of the registration process, or if the user has previously registered, the following menu screen may be displayed.

The activities menu screen consists of the following example functions:
Update Information (“Info.”)—allows the user to review and update user information.
Card Use—shows the details of transactions related to the card.
Send Me Info.—allows the user to be sent information by direct mail, email or other means.
Contact Me—allows the user to request a follow-up call at a given date and time.
Schedule Meeting—allows the user to schedule a meeting during the trade show (or at other times) by selecting date and time.
Try My Luck—allows the user to see whether the user is a winner of the sweepstakes.

This screen may also present product information and/or have additional user-selectable controls to bring up product information or demos.

Other controls may also be available for additional services offered by the product display kiosk, such as for games or local hotel, restaurant, or other reservations.

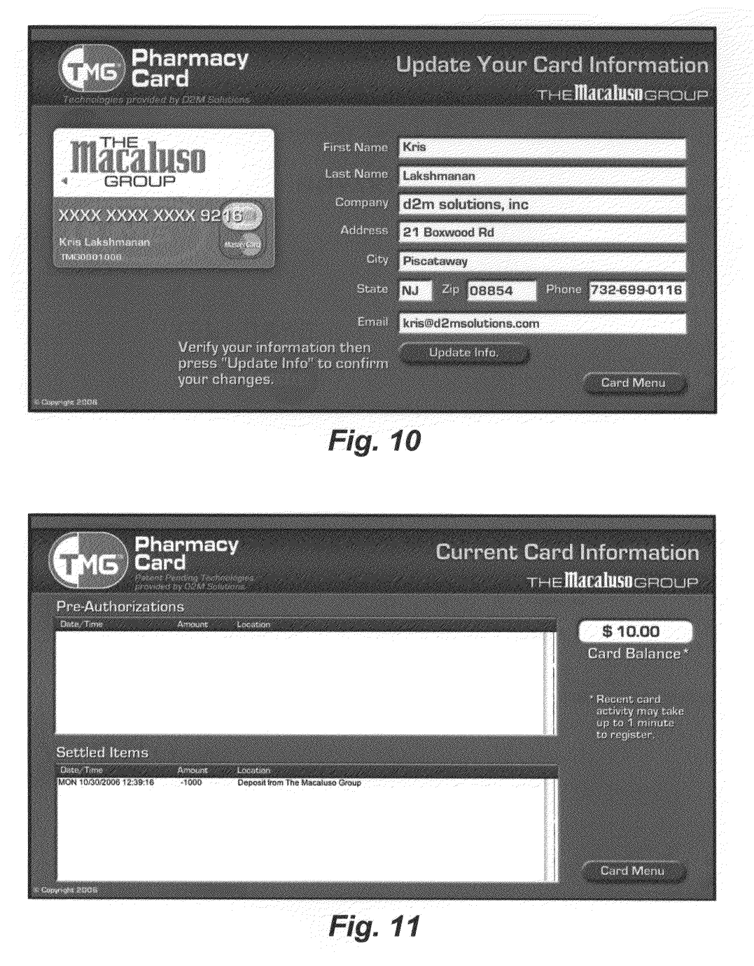

FIG. 10: Update Screen:

The update screen dialog allows a user to update existing data about the user. This screen can be reached by, for example, selecting the “Update Info” button in FIG. 9.

FIG. 11: Card Use Screen:

The Card Use Screen provides information about an account associated with the card.

The screen can be reached, for example, by selecting the “Card Use” button in FIG. 8. In this example, the following information may be displayed:
Card Balance—shows the current balance in the account associated with the card.
Pre-Authorization—shows recent card activity that is authorized and pending settlement.
Settled Items—shows deposits and settlements of the financial transactions.

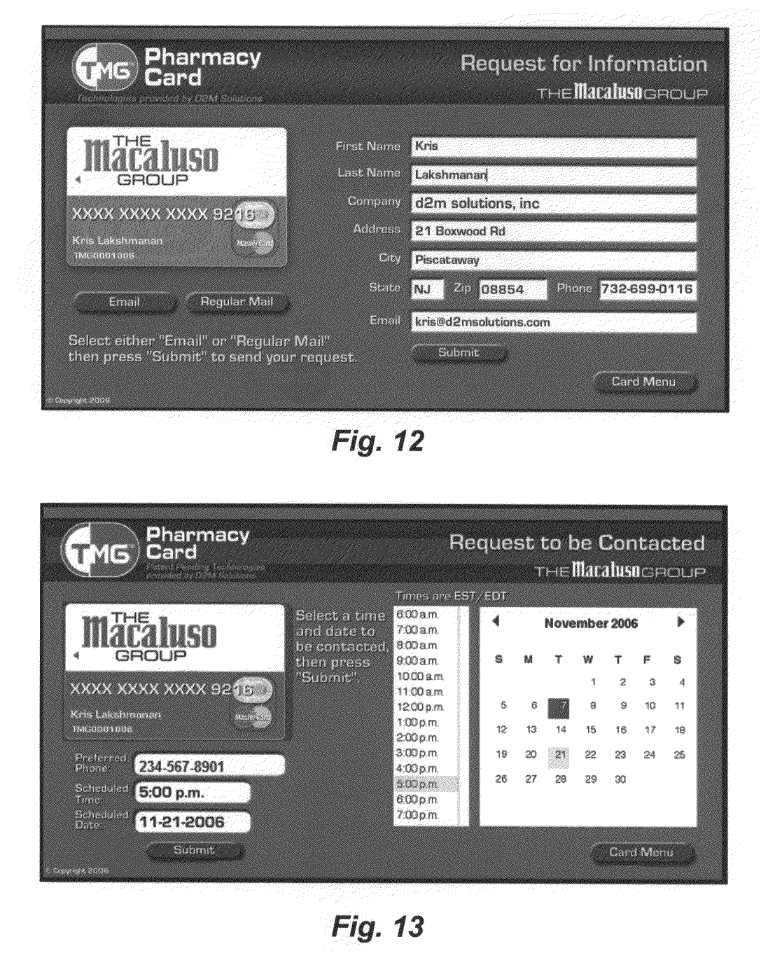

FIG. 12: Request for Information Screen:

The request for information screen allows the user to request product information, which can be subsequently provided by email, direct mail, or other means.

The screen may be reached, for example, by selecting the “Send me Info” button in FIG. 8.

The user selects the appropriate method for receipt (e.g., email or regular mail) and completes the request by selecting the “Submit” button.

FIG. 13: Request for Contact Screen:

The request for contact screen allows the user to schedule a date and time for future contact with the vendor.

Pressing the “Submit” button confirms the request.

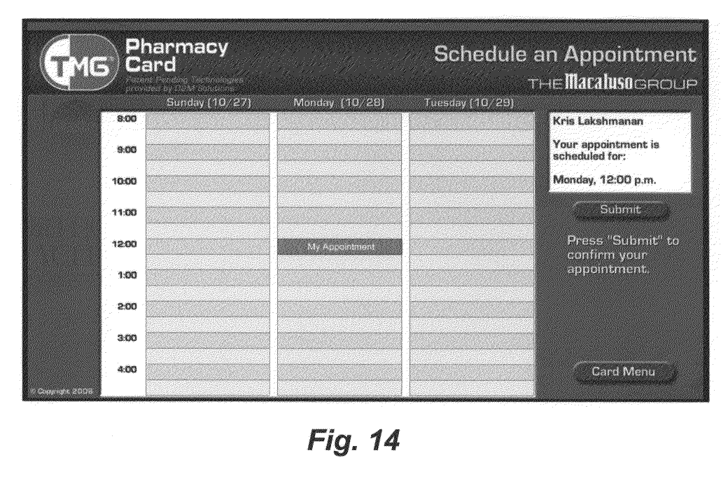

FIG. 14: Schedule Appointment Screen:

The schedule appointment screen allows a user to set up an appointment related to products or services.

The available days and times slots are shown and a user may pick the time slot. Slots taken by others may be marked as “reserved” in some embodiments for privacy reasons. The details of the current user current appointment(s) are shown on the right. Pressing the “Submit” button confirms the request.

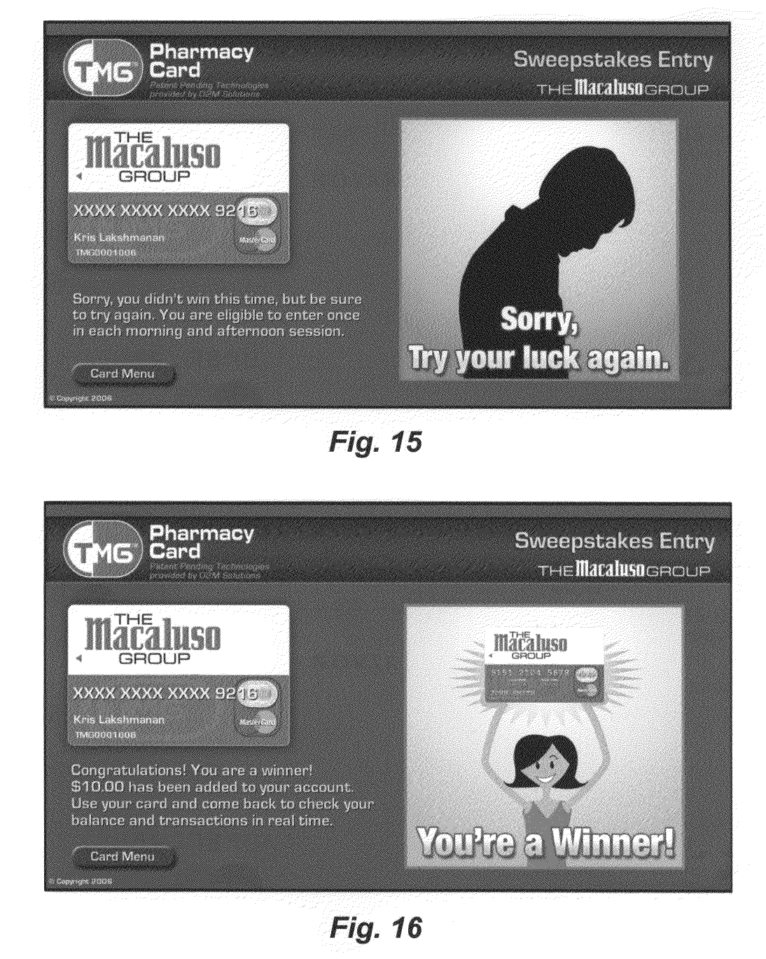

FIGS. 15 and 16: Loser and Winner Screens:

Loser and winner screens, respectively. After the user enters the sweepstakes, an appropriate message is displayed to indicate whether the user won the sweepstakes. Additional visual and sound effects can be displayed to catch the attention of other people walking near the product or service display.

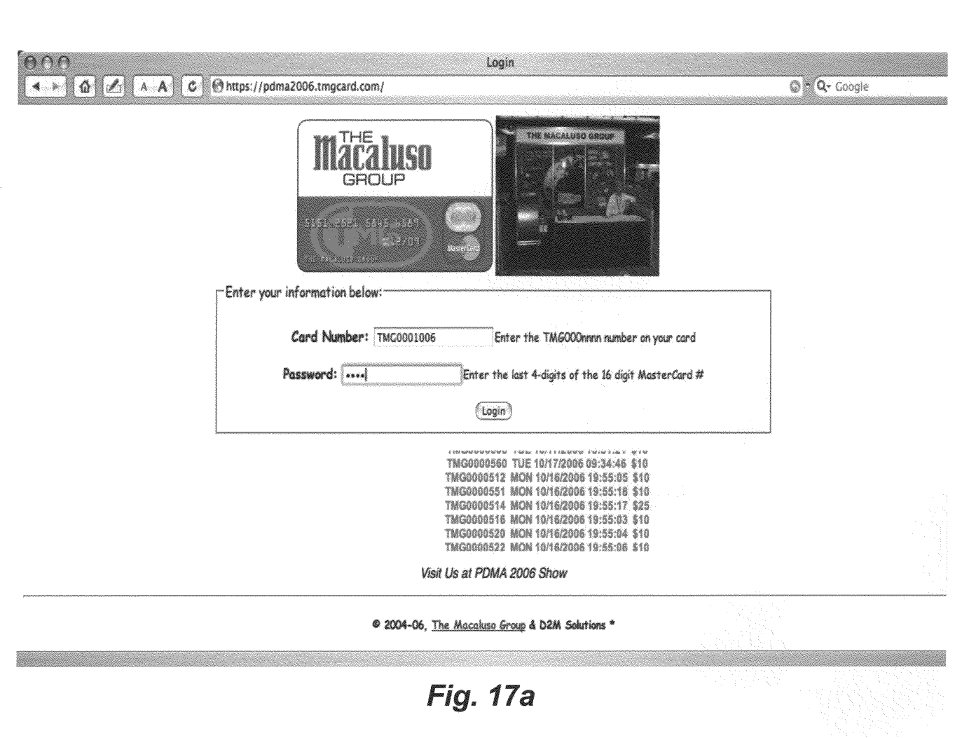

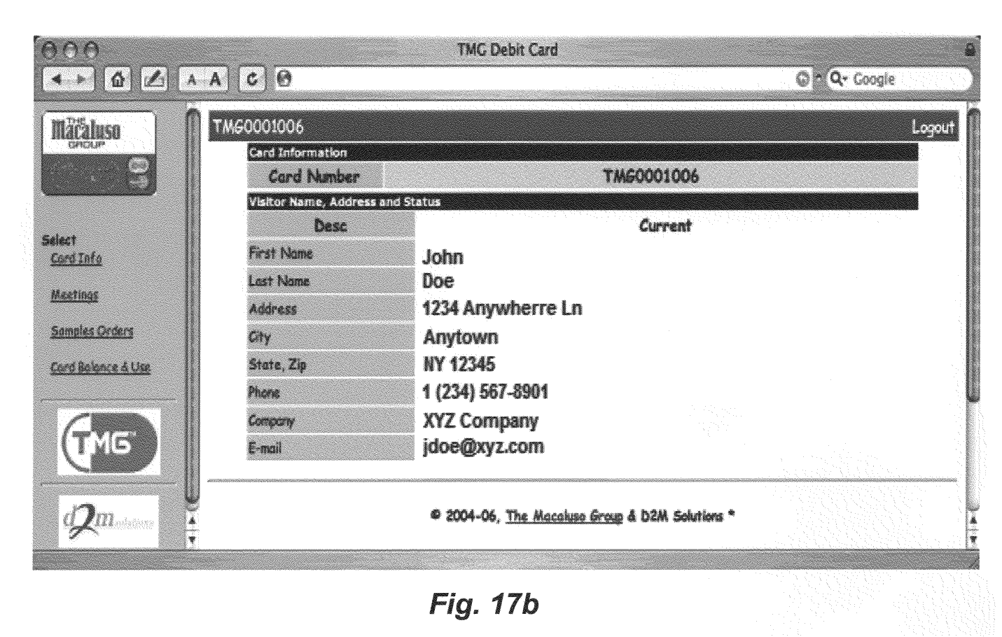

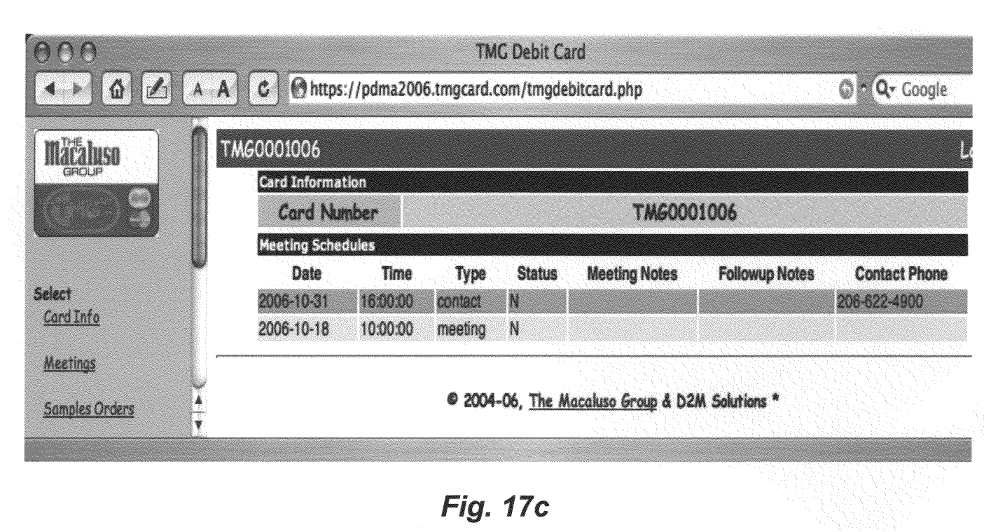

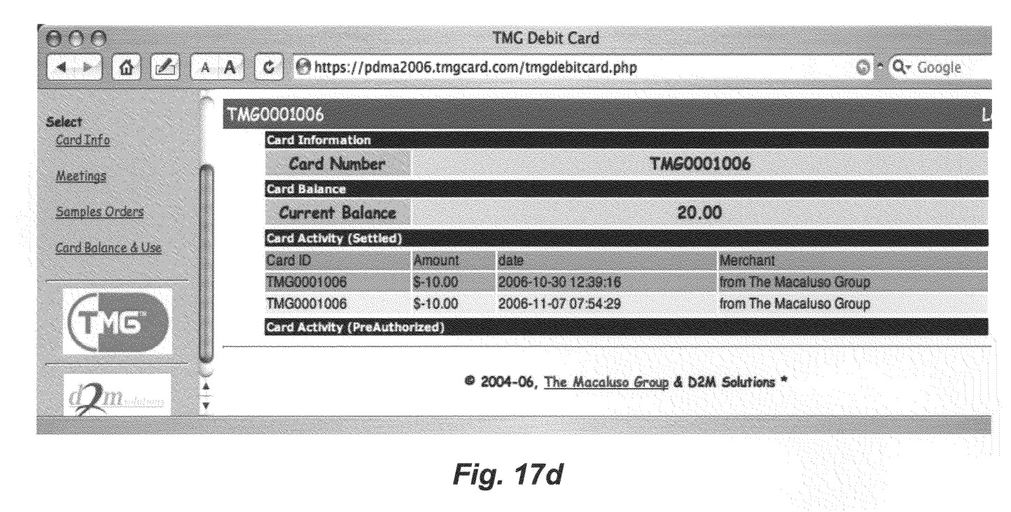

FIG. 17a-17d: Web Portal Screenshots:

The web portal allows a card holder to view and update various information using a client application such as a web browser.

The information available via the web portal may include:
Card usage (e.g., associated debits or credits and use at vendors).
Scheduled contacts with the vendor including at the trade show and at other times.
Contact information for the card holder.
Current sweepstakes winner information.
Product and/or service information.

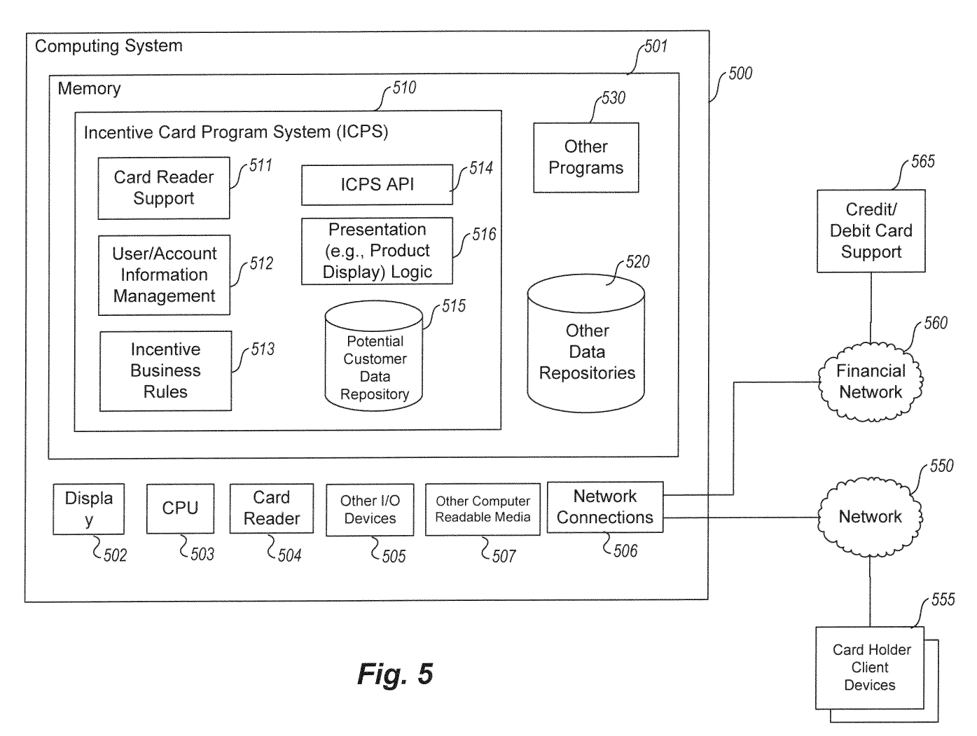

FIG. 5 is an example block diagram of an example computing system that may be used to practice embodiments of an Incentive Card Program System. Note that a general purpose or a special purpose computing system may be used to implement an “ICPS.” For example, a special purpose or customized kiosk as described above may implement the various components of an ICPS. Further, the ICPS may be implemented in software, hardware, firmware, or in some combination to achieve the capabilities described herein.

The computing system 500 may comprise one or more server and/or client computing systems and may span distributed locations. In addition, each block shown may represent one or more such blocks as appropriate to a specific embodiment or may be combined with other blocks. Moreover, the various blocks of the ICPS 510 may physically reside on one or more machines, which use standard (e.g., TCP/IP) or proprietary interprocess communication mechanisms to communicate with each other.

In the embodiment shown, computing system 500 comprises a computer memory (“memory”) 501, a display 502, one or more Central Processing Units (“CPU”) 503, a Card Reader 504 (or other input reading system), Input/Output devices 505 (e.g., keyboard, mouse, CRT or LCD display, etc.), other computer-readable media 507, and one or more network connections 506. The Incentive Card Program System (“ICPS”) 510 is shown residing in memory 501. In other embodiments, some portion of the contents, some of, or all of the components of the ICPS 510 may be stored on and/or transmitted over the other computer-readable media 507. The components of the Incentive Card Program System 510 preferably execute on one or more CPUs 503 and manage the use of incentive cards for acquiring event attendee/visitor information and for presenting product/service information, as described in previous figures and text. Other code or programs 530 and potentially other data repositories, such as data repository 520, also reside in the memory 510, and preferably execute on one or more CPUs 503. Of note, one or more of the components in FIG. 5 may not be present in any specific implementation.

In a typical embodiment, the ICPS 510 includes one or more card reader (or equivalent) support modules 511, one or more user/account information management modules 512 for tracking card holders and associated information, one or more incentive business rules modules 513 for providing the logic and implementation of business rules associated with incentives, one or more presentation modules 516 for providing logic for the presentation of information relating to services and/or products, an application programming interface 514 for gaining access to ICPS data, and one or more data repositories for storing ICPS information such as potential customer data. The ICPS may interact with incentive card credit/debit support 565 via a financial network 560 (such as a credit card secure network), and optionally with client applications, browsers, etc. 555 via a network 550 such as to present access to a web portal for viewing card holder information as described above. Of note, one or more of these components may be excluded as desired for a particular embodiment. Other and/or different modules/components may be implemented. In an example embodiment, components/modules of the ICPS 510 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.) etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computing systems each having one or more CPUs. Some embodiments are illustrated as executing concurrently and asynchronously and communicating using message passing techniques. Equivalent synchronous embodiments are also supported by an ICPS implementation.

In addition, programming interfaces to the data stored as part of the ICPS process (e.g., in the data repository 520) can be available by standard means such as through C, C++, C#, and Java APIs; libraries for accessing files, databases, or other data repositories; through scripting languages such as XML; or through Web servers, FTP servers, or other types of servers providing access to stored data. The data repository 515 may be implemented as one or more database systems, file systems, or any other method known in the art for storing such information, or any combination of the above, including implementation using distributed computing techniques. In addition, the incentive business rules 513 and Presentation Module 516 may be implemented as stored procedures, or methods attached to incentive card “objects,” although other techniques are equally effective.

Also the example ICPS 510 may be implemented in a distributed environment comprising of multiple, even heterogeneous, computer systems and networks. For example, in one embodiment, the User/Account Information 512, the Incentive Business Rules 513, and the ICPS data repository 515 are all located in physically different computing systems. In another embodiment, various components of the ICPS 510 are hosted each on a separate server machine and may be remotely located from the tables which are stored in the ICPS data repository 515. Also, one or more of the components may themselves be distributed, pooled or otherwise grouped, such as for load balancing, reliability or security reasons. Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an ASCS.

Furthermore, in some embodiments, some or all of the components of the ICPS may be implemented or provided in other manners, such as at least partially in firmware and/or hardware, including, but not limited to one ore more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be transmitted as contents of generated data signals (e.g., by being encoded as part of a carrier wave or otherwise included as part of an analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It will also be appreciated that various modifications may be made in various embodiments. For example, various types of cards and other payment media may be utilized in other embodiments, such as gift cards (whether for a vendor or not) or RFID-based payment media. Moreover, in addition to branding the card, the card may be made in custom shapes or out of custom materials to meet the needs of the vendor. In addition, in at least some embodiments, the prize may be a monetary credit for one or more products of the vendor. Furthermore, auxiliary information may be displayed as well, such as hotels, restaurants, or entertainment venues in the area, including the possibility of making a reservation at those hotels, restaurants, or venues. Moreover, it will be appreciated that in some embodiments there may be multiple product/service display kiosks, such as multiple kiosks at a trade show booth or a single product kiosk in each store or showroom.

From the foregoing it will be appreciated that, although specific embodiments have been described herein for purposes of illustration, various modifications may be made without deviating from the spirit and scope of the invention. For example, one skilled in the art will recognize that the methods and systems for facilitating marketing products and/or services discussed herein are applicable to other architectures other than a stand-alone kiosk architecture. For instance, the methods and systems for attracting customers to product displays discussed herein are applicable in situations other than trade shows, such as product displays in retail stores, in show rooms, at meetings, at continuing education events, etc. One skilled in the art will also recognize that the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A method in a computing system for facilitating attracting potential customers to product presentations, comprising:
receiving an indication that a card has been swiped in a receiving device, the card having a unique identifier and associated with an account;
determining information about a potential customer;
presenting information to the potential customer about one or more products or services;
determining if the potential customer is a winner in a contest according to one or more criteria; and
when the potential customer is determined to be a winner, causing a monetary amount to be electronically deposited into the account associated with the swiped card.

2. The method of claim 1, further comprising:
at a subsequent time,
receiving an indication that the card has been swiped in the receiving device;
automatically determining if the potential customer is eligible to participate again in the contest based on one or more business rules; and
when the potential customer is eligible to participate in the contest again,
determining if the potential customer is a winner according to the one or more criteria; and
when the potential customer is a winner, causing a monetary amount to be electronically deposited into the account associated with the swiped card.

3. The method of claim 2 wherein the business rules limit the eligibility of the potential customer to participate in the contest based upon at least one of a predetermined number of attempts in a calendar period of time, a predetermined number of attempts per event, or a single attempt within a rolling predetermined period of time.

4. The method of claim 1 wherein the computing system is located at an event, and the card is distributed to the potential customer during the event.

5. The method of claim 1 wherein the computing system is at an event and the card is distributed to the potential customer prior to the event.

6. The method of claim 1 wherein the computing system is a product kiosk located in a store.

7. The method of claim 1 wherein the computing system is located at one of an event, a trade show, a meeting, or a store.

8. The method of claim 1, further comprising receiving an indication that the potential customer desires an appointment with a representative of a vendor of the one or more products; and causing an appointment to be scheduled for the potential customer.

9. The method of claim 8 wherein the computing system is at a booth at a trade show and the appointment is an appointment during the trade show.

10. The method of claim 8 wherein the computing system is at a booth at a trade show and the appointment is an appointment after the trade show.

11. The method of claim 1, further comprising, in response to receiving an indication to provide product information to the potential customer at a later time, facilitating providing product to the potential customer.

12. The method of claim 1 wherein the card is at least one of a debit card or a gift card.

13. The method of claim 1 wherein the determining information about the potential customer comprises:
receiving an indication of a phone number associated with the potential customer; and
determining at least some of the information about the potential customer by performing a directory lookup on the indicated phone number.

14. The method of claim 1 wherein the one or more products are offered by a vendor and the determined information about the potential customer includes one or more fields customized for that vendor.

15. The method of claim 1 wherein the criteria for determining if the potential customer is a winner is to randomly select a winner in accordance with predetermined odds.

16. The method of claim 1 wherein the criteria for determining if the potential customer is a winner is to randomly select a winner until a predetermined amount of money is won.

17. The method of claim 1 wherein the monetary amount is a predetermined amount of money.

18. The method of claim 1 wherein the monetary amount is automatically determined according to the one or more criteria.

19. The method of claim 1, further comprising:
in response to a request from the potential customer, providing information about a balance of the account associated with the swiped card.

20. The method of claim 19 wherein the request from the potential customer is received via a network.

21. The method of claim 1 wherein the method is performed for multiple potential customers.

22. The method of claim 21, further comprising displaying at least one winner.

23. The method of claim 1, further comprising presenting information to the potential customer about one or more local establishments.

24. The method of claim 1 wherein at least one of the one or more products is a service.

25. The method of claim 24 wherein the service is not provided by the computing system.

26. The method of claim 1 wherein the computing system is provided by an entity other than a vendor of the one or more products.

27. The method of claim 26, further comprising providing the determined information about the potential customer to the vendor of the one or more items.

28. A computer-readable medium containing instructions that, when executed, control a computer processor to perform at least one of the methods of claims 1-27.

29. A debit card incentive program kiosk system for performing at least one of the methods of claims 1-27.

30. A method for conducting an incentive card program to facilitate marketing one or more products, comprising:
distributing to each of one or more potential customers an incentive card; and
providing one or more display kiosks that perform at least one of the methods of claims 1-27.

31. A kiosk comprising:
means for receiving an indication that a card has been swiped in a receiving device, the card having a unique identifier and associated with an account;
means for determining information about a potential customer;
means for presenting information to the potential customer about one or more products or services;
means for determining if the potential customer is a winner in a contest according to one or more criteria; and
means for causing a monetary amount to be electronically deposited into the account associated with the swiped card when the potential customer is determined to be a winner.
